(19) United States
(12) Patent Application Publication
(10) Pub. No.: US 2025/0142611 A1
(43) Pub. Date: May 1, 2025

(54) SYSTEMS AND METHODS FOR PROVIDING SERVICES BASED ON AN INITIAL BLOCK ERROR RATE DETERMINED FROM A TRANSLATED CHANNEL QUALITY INDICATOR TABLE

(71) Applicant: Verizon Patent and Licensing Inc., Basking Ridge, NJ (US)

(72) Inventors: Jack Anthony SMITH, Burkburnett, TX (US); Chin CHIU, Allen, TX (US); Asif Dawoodi GANDHI, Edison, NJ (US); Susan Wu SANDERS, Bridgewater, NJ (US)

(73) Assignee: Verizon Patent and Licensing Inc., Basking Ridge, NJ (US)

(21) Appl. No.: 18/495,299

(22) Filed: Oct. 26, 2023

(51) Int. Cl. H04W 72/542; H04B 7/06; H04L 1/00; H04L 1/20

(52) U.S. Cl. CPC H04W 72/542; H04B 7/0632; H04L 1/0026; H04L 1/203

(57) ABSTRACT

A network device may select a target reliability from a table that includes a list of target reliabilities not associated with a default reliability, and may provide the target reliability to a user equipment. The user equipment may be configured to associate the target reliability with a channel quality indicator (CQI) process that computes CQI values that satisfy the target reliability.

### BACKGROUND

Fifth generation (5G) telecommunication networks are designed to provide services at ultra-high speeds and with ultra-low latencies. In order to achieve such ultra-high speeds and ultra-low latencies, a 5G network must select an optimum quantity of data to be sent in each transmission attempt based on resources allocated for that transmission and a capability (e.g., a quality) of a channel. If the selected quantity of data is too small, then a transmission speed is less than what the channel is capable of delivering, and thus, suboptimal. If the selected quantity of data is too large, then it will likely take multiple transmission attempts to correctly deliver the data and the latency will be too large, and thus, suboptimal.

### BRIEF DESCRIPTION OF THE DRAWINGS

FIGS. 1A-1L are diagrams of an example associated with providing services based on an initial block error rate (iBLER) determined from a translated channel quality indicator (CQI) table.

FIG. 2 is a diagram of an example environment in which systems and/or methods described herein may be implemented.

FIG. 3 is a diagram of example components of one or more devices of FIG. 2.

FIGS. 4 and 5 are flowcharts of example processes for providing services based on an iBLER determined from a translated CQI table.

### DETAILED DESCRIPTION OF EXAMPLE EMBODIMENTS

The following detailed description of example implementations refers to the accompanying drawings. The same reference numbers in different drawings may identify the same or similar elements.

Selecting an optimum quantity of data to transmit in any given attempt can be problematic for a transmitter (e.g., a base station) since the base station is unable to correctly determine the optimum quantity of data to send. This is because the ability of a transmission link to convey information is closely related to a signal-to-interference ratio at a receiver (e.g., a user equipment (UE)), and only the UE is able to measure this ratio. To solve this problem, communication systems often employ a feedback approach where the UE periodically makes measurements of how much data can reliably be transmitted on a link and then reports this information back to the base station so that the base station may determine the proper quantity of data to attempt on a next transmission attempt to the UE. This process is known as a channel quality indicator (CQI) process.

Each base station may periodically transmit reference signals that can be measured by each UE in the base station's coverage area. Each UE may measure these reference signals and may use them (e.g., typically in conjunction with other measurements such as an interference level) to compute an expected link rate that might be attempted by the base station while maintaining a certain degree of reliability. The expected link rate may be expressed as a spectral efficiency (e.g., in bits per second per hertz). The degree of reliability may be expressed as an initial block error rate (iBLER).

Once the UE has determined an estimate of an optimum link rate, the UE may send this information back to the base station. The feedback methodology needs to be as efficient as possible in terms of the number of bits used to provide the information to the base station so that the entire uplink bandwidth is not consumed by feedback transmissions. A methodology used to minimize the number of feedback bits is through the use of a table known as a CQI Table. The CQI table is an agreed-upon table known by both the base station and the UE, and contains a finite number of quantized data rate options, where a range of the options typically encompasses a wide range of different operating conditions from a very low data rate to a very high data rate. The CQI Table 1 is a table that was standardized during the early days of long term evolution (LTE).

As dictated by the standard, a goal of a receiver (e.g., the UE) is to determine an index of a maximum link rate capability that could be used by a transmitter while meeting a desired transmission reliability and then reporting that index back to the transmitter (e.g., the base station). Since there are sixteen rows in a typical CQI Table, information (e.g., an index of an optimum row) can be reported using only four bits, which is a very compact method of supplying the transmitter with the information that it needs to make a proper decision regarding how much data can be sent.

A goal of the receiver is to determine which of the rows in the CQI Table would allow the transmitter to transmit a maximum amount of data in allocated resources while still meeting a target degree of reliability. If the receiver is in a very poor location, it may turn out that none of the non-zero data rate options could be employed while still meeting the target degree of reliability. If that is the case, the standard dictates that the receiver should report back CQI Index 0, which means that none of the link rates in the CQI Table allow the transmitter to send data at the required degree of reliability. Unlike other CQI index values, which basically indicate a link rate capability to within a very narrow window of uncertainty, CQI Index 0 returns almost no information. Upon receiving CQI Index 0, the transmitter cannot determine whether a link is just a fraction of a decibel outside of an acceptable range of performance or whether the link is one-hundred decibels outside of the acceptable range of performance. Basically, CQI Index 0 doesn't convey whether the transmitter would have to transmit twice in order for the receiver to be able to successfully decode the transmission or whether the transmitter could transmit five times and there would still be no successful decoding.

CQI Table 1 provides the receiver with the ability to report back a current link quality for most of the range of link qualities expected to be encountered using hardware capabilities and expected deployment scenarios. Also, since the data transmission goal was the efficient transmission of data, the LTE standard dictated that a target degree of reliability that the receiver should employ when using the CQI Table 1 was a target of a 10% iBLER. This enabled enough aggressiveness that a packet transmission would fail every so often, but not enough so that failures consumed the link with retransmissions.

Once CQI feedback information is received by the transmitter, the transmitter typically performs processing on the feedback information to smooth errors caused by noise and other factors before deciding on an actual rate to use for a transmission attempt. When making this selection, the transmitter also selects from a table of quantized data rates known by both the transmitter and the receiver since the receiver would need to be informed of the transmission rate that was being attempted so that the receiver may know what modulation and coding was used for the transmission. When making this selection, the transmitter selects a data rate by selecting a row from a table known as an MCS Table that contains information similar to the CQI Table. However, the MCS Table is used to indicate back to the receiver exact parameters used for a transmission after the transmitter has performed processing on the CQI feedback information and made a selection.

An example of such an MCS table is MCS Table 1, defined in the LTE standard. The MCS Table 1 contains very similar fields as the CQI Table 1. There are a number of rows, with each row containing a number known as an MCS Index, along with parameters to be used when coding and decoding a transmission and a spectral efficiency that results. A difference between the CQI table and the MCS table is that the MCS table has twice as many rows as the CQI table. This may enable the transmitter to select a transmission rate that is as close as possible to the transmission rate that the transmitter determines to be the optimum transmission rate after processing the CQI feedback. Typically, the CQI feedback is somewhat noisy since the CQI feedback is based on ever-fluctuating interference levels, and thus there is no need to be overly exact in specifying the rate during the CQI feedback. The transmission rate that is determined at the transmitter after the transmitter performs processing on the CQI feedback is somewhat more reliable and so it makes sense to have the additional rows in the MCS table to provide the transmitter with the ability to get as close to a computed optimum rate as possible.

The LTE standard utilizes the CQI Table 1, which contains quantized link rate capabilities within a range of 0.1523 bits/seconds(s)/hertz (Hz) and 5.5547 bits/s/Hz, and dictates that a 10% iBLER target should be employed whenever the receiver is determining which CQI index to feedback based on the CQI Table 1. The CQI feedback is then processed at the transmitter and used to select an actual transmission rate by choosing one of the transmission rates enumerated in the MCS Table 1.

In order to take advantage of higher signal-to-interference values while still employing the same practices and processes that were already developed for LTE, an additional CQI table (e.g., CQI Table 2) and an additional MCS table (e.g., MCS Table 2) were added to the LTE standard.

The CQI Table 2 uses the same lower range of performance (e.g., 0.1523 bits/s/Hz) as the CQI Table 1, but a step up in performance between consecutive rows is now larger, and this enables a maximum range of performance to be increased to 7.4063 bits/s/Hz, which can now be achieved using 256 quadrature amplitude modulation (QAM) as the modulation technique, rather than 64 QAM, which was the most spectrally-efficient modulation technique allowed using the CQI Table 1. A target iBLER for the CQI Table 2 was mandated to be 10⁻¹ probability of initial block error.

With the launch of 5G, the LTE standard needs to address 5G features, such as supporting ultra-reliable low-latency communications (URLLC) applications. To support URLLC applications, the LTE standard added another CQI table, known as CQI Table 3. The CQI Table 3 shifts the focused range of performance to a low end of the spectral efficiency range. The CQI Table 3 enables the receiver to report link rate capabilities that go all the way down to 0.0586 bits/s/Hz, while limiting the maximum performance range to 4.5234 bits/s/Hz. The new lower limit of 0.0586 bits/s/Hz represents an extension in performance associated with the use of up to 2.6 times more coding applied to the link than was previously available, which helps the link to be more reliable in poor locations. The corresponding MCS table for CQI Table 3 is MCS Table 3.

When the CQI Table 3 was added, the standard mandated that when the receiver is configured to use CQI Table 3, the receiver must compute and report the CQI feedback using a 10⁻⁵ iBLER target in an attempt to guarantee that a transmission is received on a first transmission attempt, and thus provided a mechanism for low-latency communications.

However, mandating an associated target reliability that should be used with a particular CQI Table has drawbacks. For example, the improved levels of coding that can be employed using the first few rows of the CQI Table 3 have applications that extend far beyond URLLC applications. A simple example of this is that the use of the additional coding rates corresponding to MCS indices zero through five may provide a transmission link with the ability to penetrate, on average, an additional six decibels into a building, which corresponds to an additional twelve meters into the building.

While current 5G UEs may incorporate the MCS Table 3, they do not necessarily include the CQI Table 3. While support of the MCS Table 3 has only minimal impact on the UE, support of a 10⁻⁵ iBLER target (e.g., which is a mandated iBLER for the CQI Table 3) may have a huge impact on UE performance. Thus, the standard currently provides three different CQI tables that can be used when the receiver determines an appropriate CQI value to feedback, and mandates that a 10⁻¹ iBLER target be used for the CQI Table 1 and the CQI Table 2, and a 10⁻⁵ iBLER target be used for the CQI Table 3. The usefulness of the CQI Table 3 extends beyond URLLC applications, as long as it is possible to use a 10⁻¹ iBLER target for these other applications. The current practice of using an iBLER target that is pre-mandated for each CQI table becomes more problematic as use cases become more complex. Furthermore, it may require several years after standard changes for those changes to make it into UEs offered for sale, and real benefits may be obtained through the use of the MCS Table 3 and the CQI Table 3 with a target iBLER of 10⁻¹.

Thus, current techniques for utilizing CQI tables and MCS tables consume computing resources (e.g., processing resources, memory resources, communication resources, and/or the like), networking resources, and/or other resources associated with failing to utilize new MCS table options that provide more channel coding, failing to enable use of the MCS Table 3 and use of CQI Table 3, failing to provide services associated with a particular iBLER (e.g., increased building penetration by a base station, additional link margin to overcome shadow fades, increased cell range for a base station, etc.), and/or the like.

Some implementations described herein provide a network device (e.g., a base station) that provides services based on an iBLER determined from a translated CQI table. For example, the base station may select a target reliability from a table that includes a list of target reliabilities not associated with a default reliability, and may provide the target reliability to a UE. The UE may be configured to associate the target reliability with a CQI process that computes CQI values that satisfy the target reliability. In another example, the base station may transmit a reference signal, and may transmit a notification of a power level of the reference signal to a UE. The power level in the notification may be increased or decreased from a particular value to cause the UE to translate a result of a computation performed by the UE.

In this way, the base station provides services based on an iBLER determined from a translated CQI table. For example, the base station may configure a target iBLER value regardless of a CQI table that is configured. Each CQI table may include a default iBLER value that may be utilized when a configuration process fails to specify a replacement iBLER value. The base station may specify a default iBLER value of the CQI Table 1 as 10⁻¹, a default iBLER value of the CQI Table 2 as 10⁻¹, and a default iBLER value of the CQI Table 3 as 10⁻⁵. The base station may set default iBLER values of any additional CQI tables that are defined in the future to values that are deemed appropriate for the additional CQI tables. Thus, the base station may conserve computing resources, networking resources, and/or other resources that would have otherwise been consumed by failing to utilize new MCS table options that provide more channel coding, failing to enable use of the MCS Table 3 and use of CQI Table 3, failing to provide services associated with a particular iBLER (e.g., increased building penetration by a base station, additional link margin to overcome shadow fades, increased cell range for a base station, etc.), and/or the like.

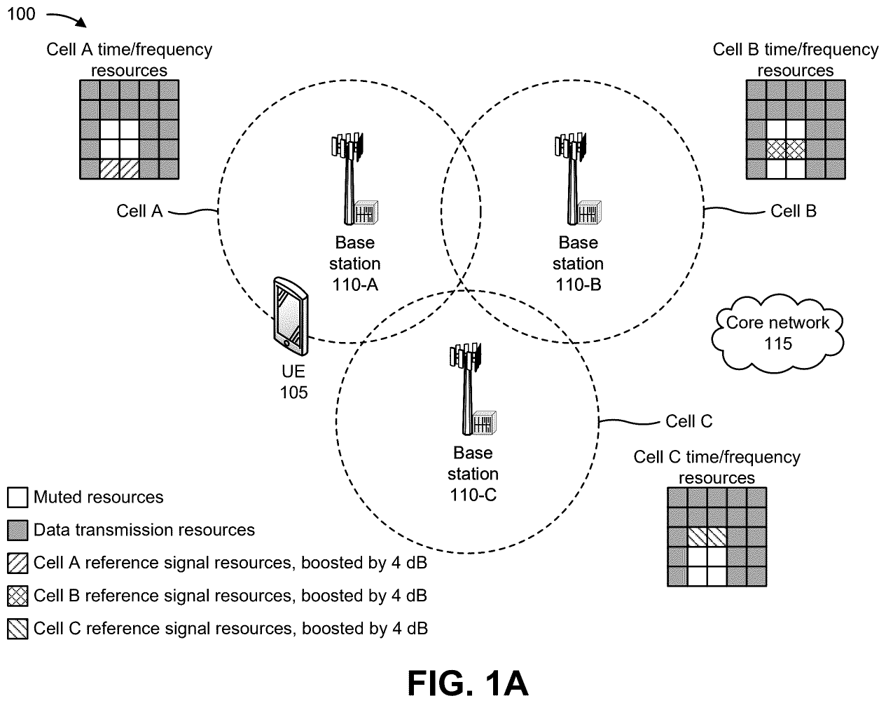

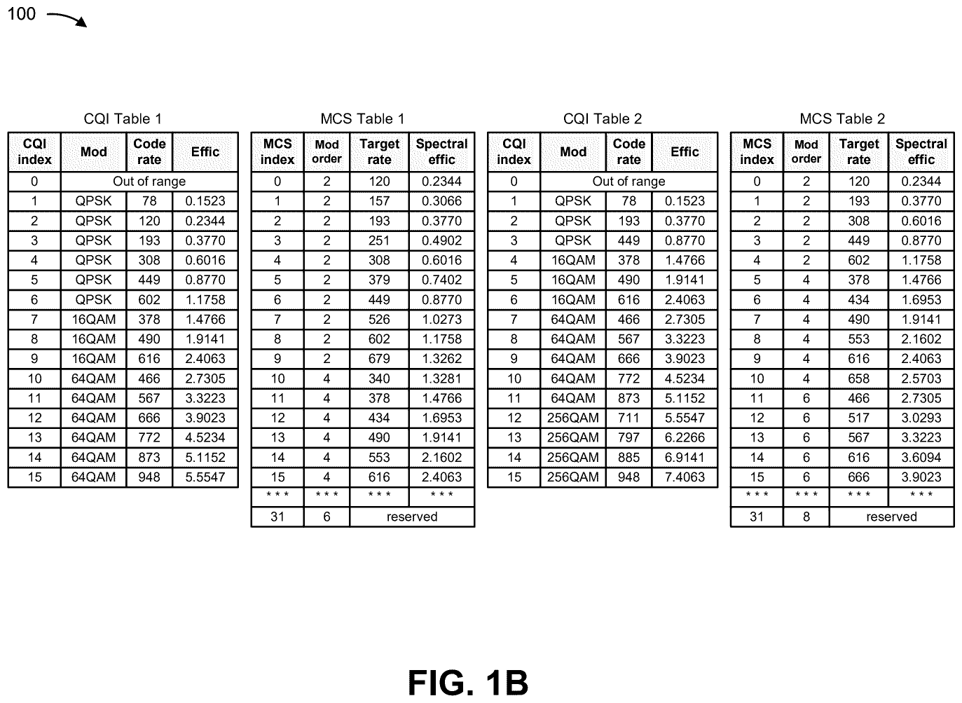

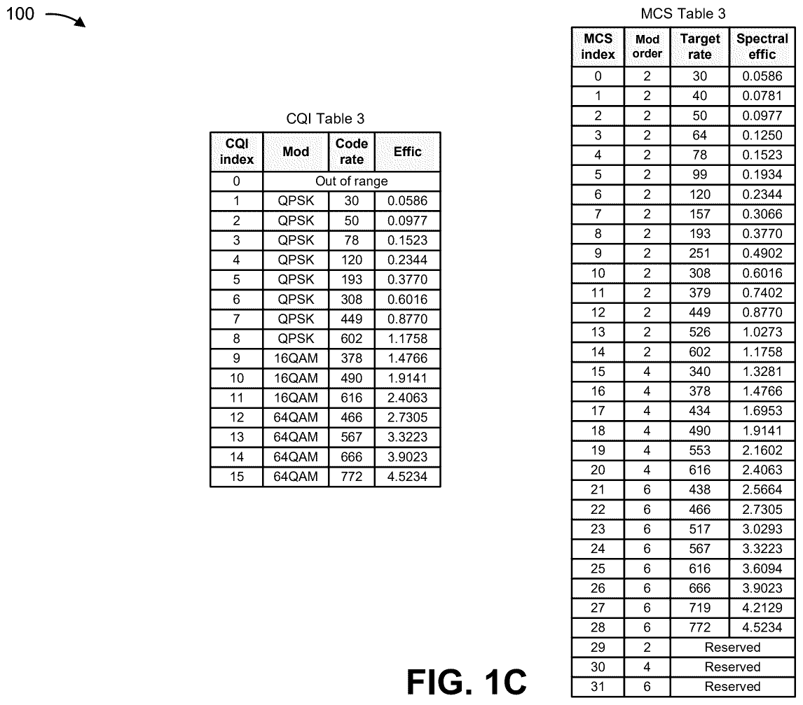

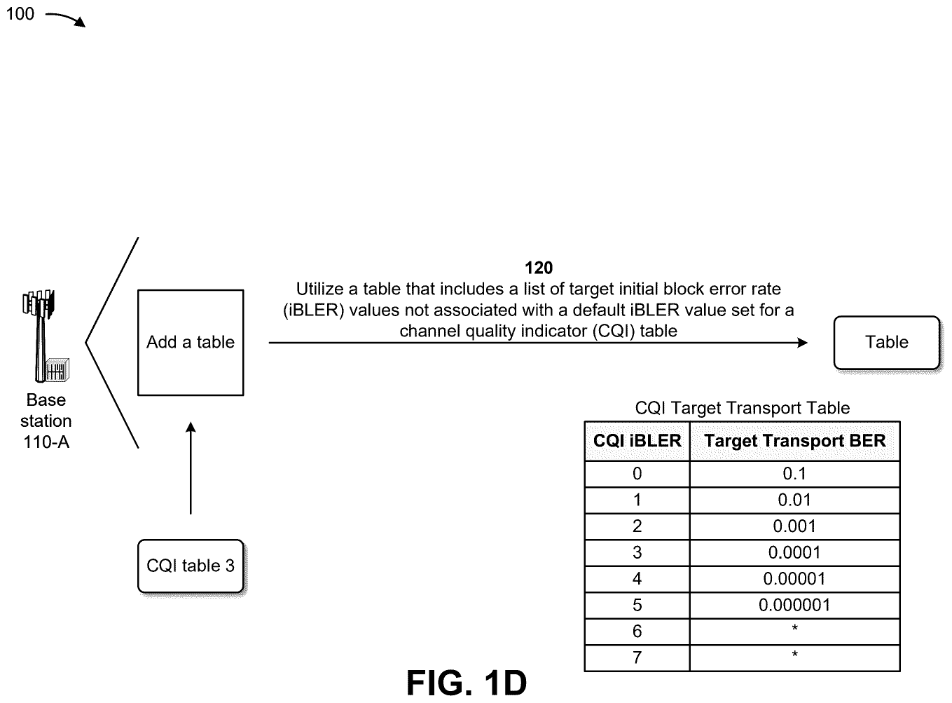

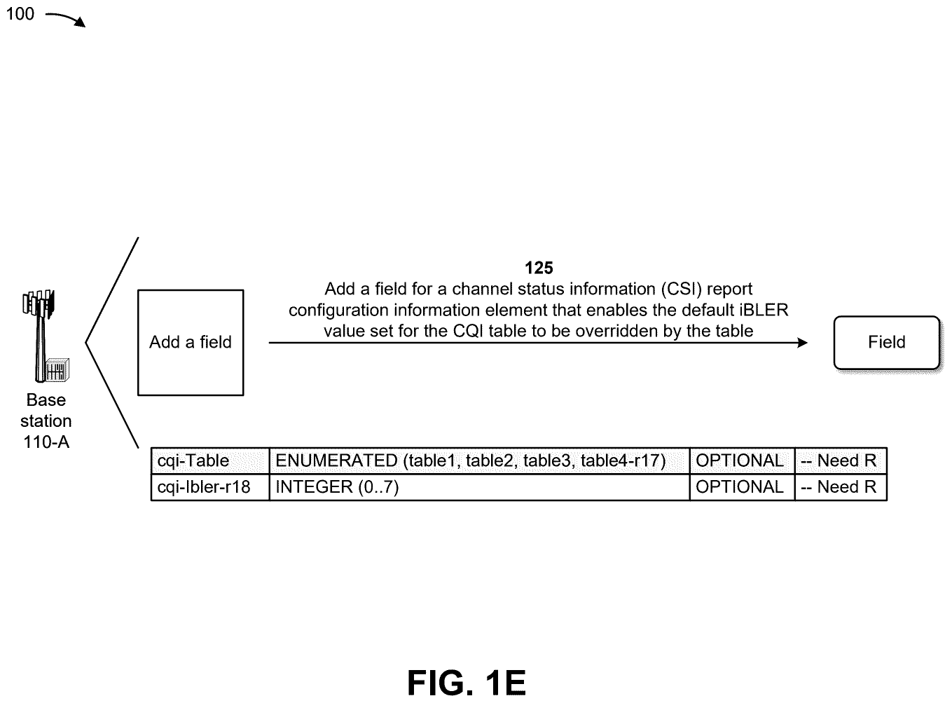

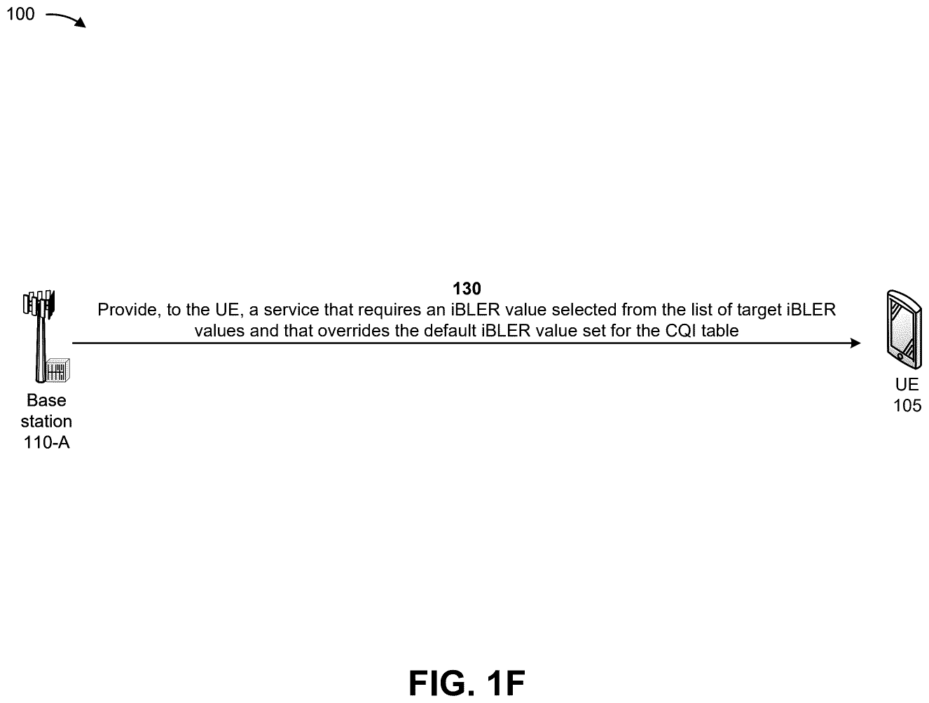

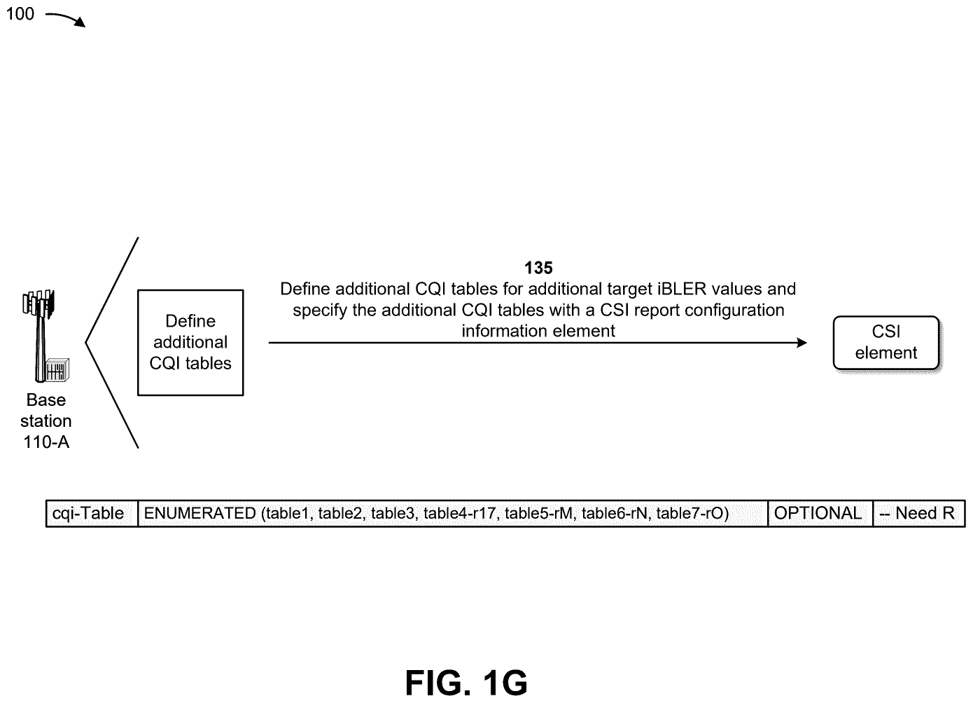

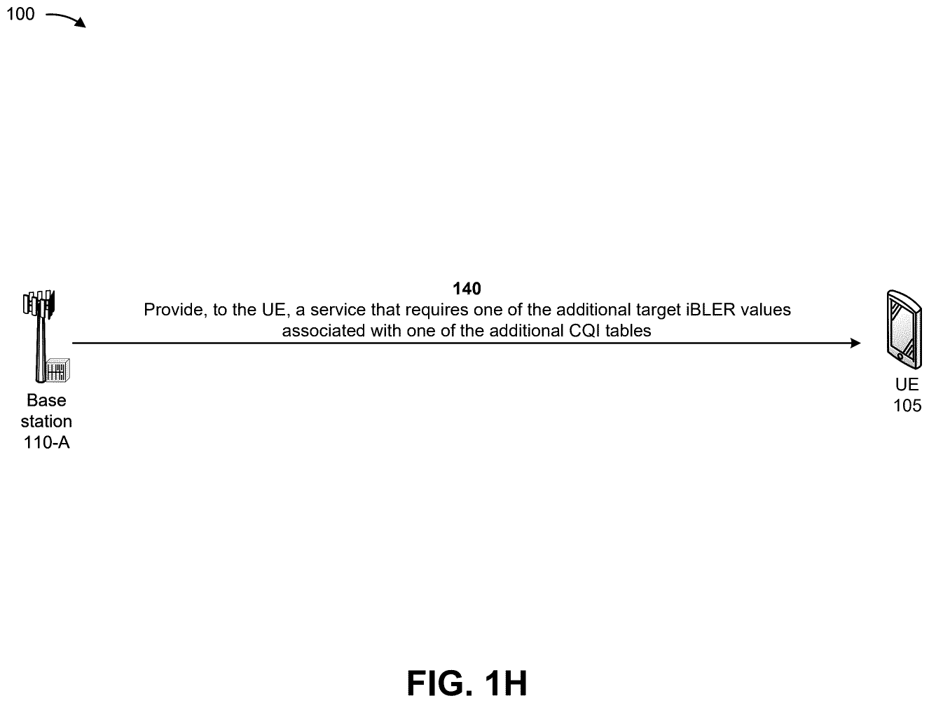

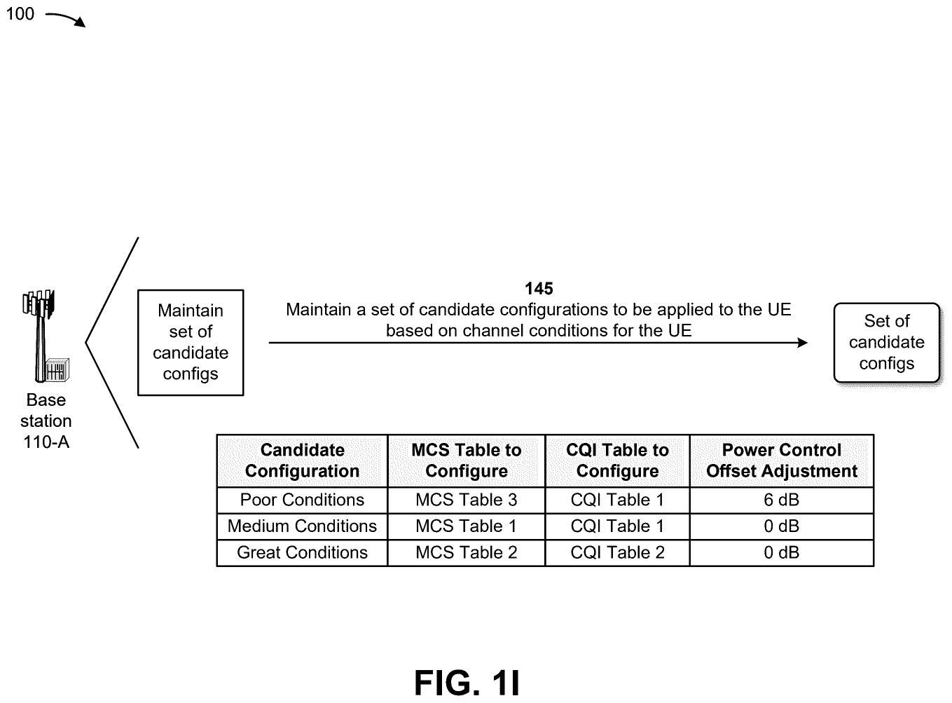

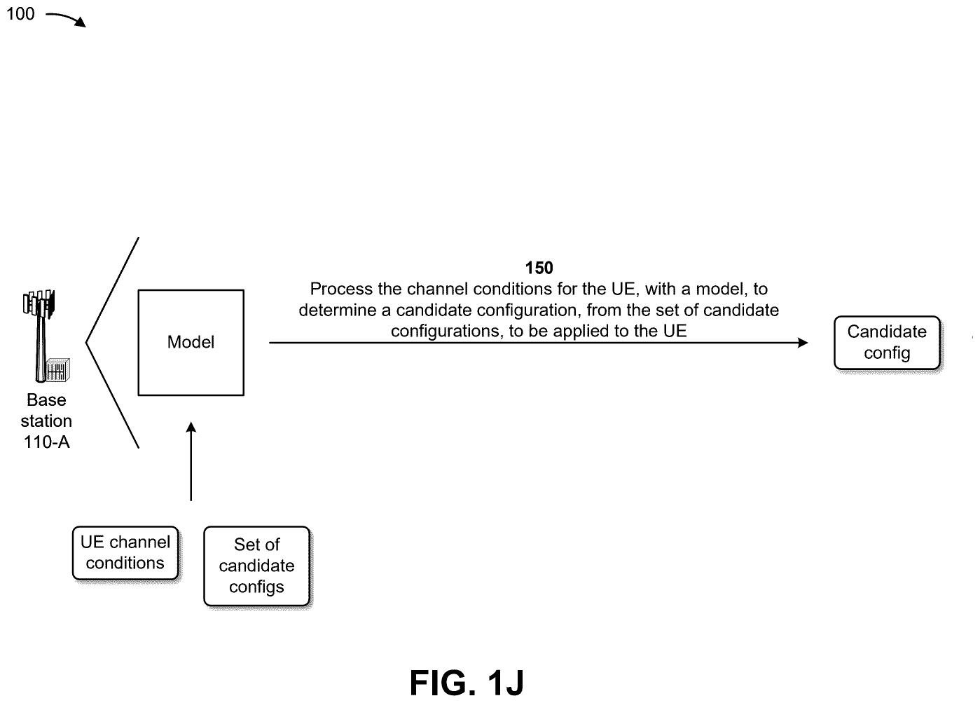

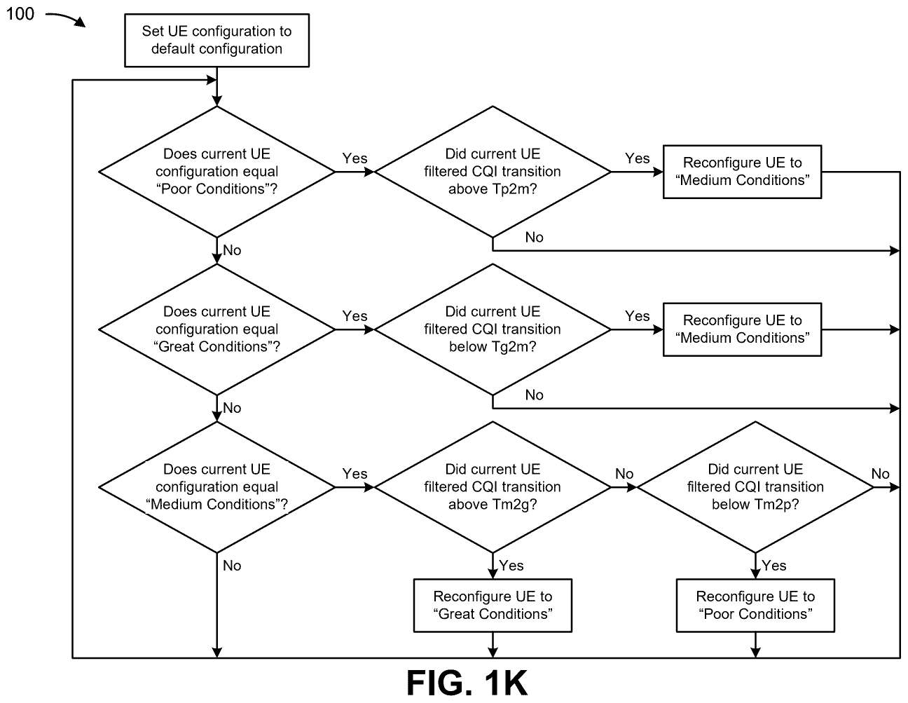

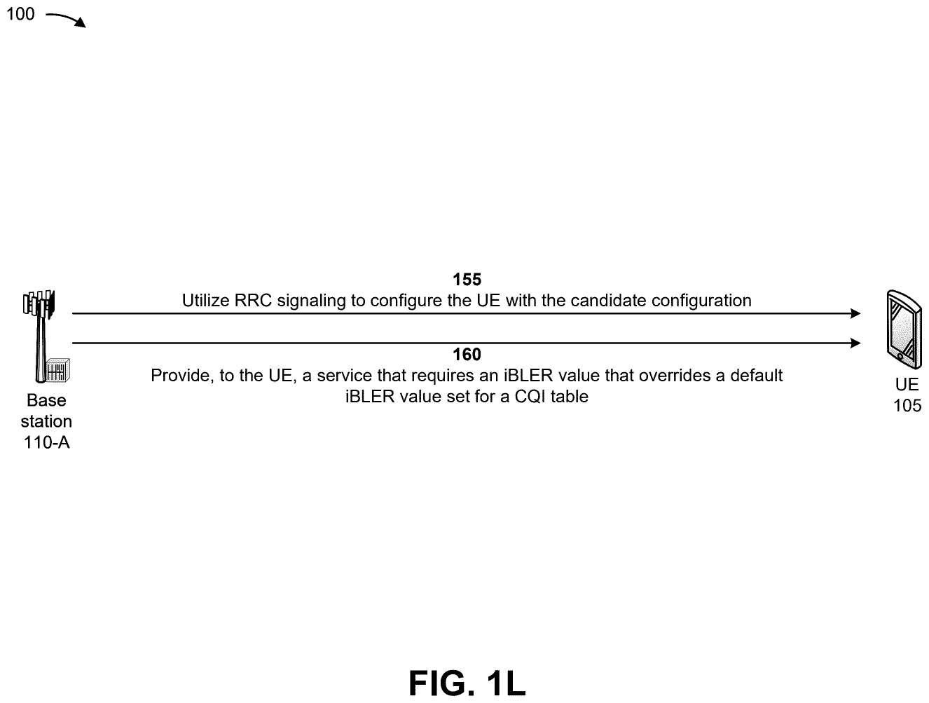

FIGS. 1A-1L are diagrams of an example 100 associated with providing services based on an iBLER determined from a translated CQI table. As shown in FIGS. 1A-1L, example 100 includes a UE 105 associated with base stations 110 (e.g., base station 110-A, base station 110-B, and base station 110-C) and a core network 115. Further details of the UE 105, the base stations 110, and the core network 115 are provided elsewhere herein.

As shown in FIG. 1A, the base station 110-A may generate cell A, the base station 110-B may generate cell B, and the base station 110-C may generate cell C. Cells A-C may provide radio access network (RAN) coverage for the UE 105. Cells A-C may be geographically located adjacent to each other and the UE 105 may be located near an outer coverage limit of cell A. Each of the base stations 110 (e.g., each cell) may utilize orthogonal resources for reference signals, and each of the base stations 110 may mute resources used for reference signals in adjacent cells. Each of the base stations 110 (e.g., each cell) may utilize resources for data transmission. For example, as shown in FIG. 1A, each of the base stations 110 may utilize time/frequency resources used at each cell. Each base station 110 may include a pair of resources used as reference signals. The time/frequency resources used for the reference signals may be orthogonal between cells A-C, and for each cell, the resources used by the adjacent cells for reference signals may be muted. Because of the muting of the resources used by adjacent cells, powers of the reference signal transmissions may be boosted by four decibels (dB). The remaining time/frequency resources at each base station 110 may be used for data transmissions.

As shown in FIGS. 1B and 1C, each of the base stations 110 (e.g., the base station 110-A) may be associated with multiple CQI tables (e.g., CQI Table 1, CQI Table 2, and CQI Table 3) and multiple MCS tables (e.g., MCS Table 1, MCS Table 2, and MCS Table 3). As shown in FIG. 1B, the CQI Table 1 may include sixteen rows, with each row corresponding to a different link rate capability ranging up to 5.5547 bits/s/Hz. Each row may be associated with four columns, such as a CQI Index column, modulations assumed for a link column, coding rates assumed for the link column, and a spectral efficiency column.

As further shown in FIG. 1B, the MCS Table 1 may include similar fields as the CQI Table 1. The MCS Table 1 may include a quantity of rows, with each row being associated with an MCS Index, parameters to be used when coding and decoding a transmission, and a spectral efficiency that results. A difference between the CQI Table 1 and the MCS Table 1 is that the MCS Table 1 may include twice as many rows as the CQI Table 1. The additional rows may enable the transmitter (e.g., the base station 110-A) to select a transmission rate that is as close as possible to a transmission rate that the transmitter determines to be an optimum transmission rate after processing CQI feedback.

As further shown in FIG. 1B, the CQI Table 2 may utilize the same lower range of performance (e.g., 0.1523 bits/s/Hz) as the CQI Table 1, but a step up in performance between consecutive rows is larger. This allows a maximum range of performance to be increased to 7.4063 bits/s/Hz, which can now be achieved using 256 QAM as a modulation technique, rather than 64 QAM, which was the most spectrally-efficient modulation technique allowed using the CQI Table 1. A target iBLER for the CQI Table 2 may be mandated to be 10⁻¹ probability of initial block error. As further shown in FIG. 1B, the MCS Table 2 may include similar fields as the MCS Table 1, but those fields may correspond to values provided in the CQI Table 2 rather than values provided the CQI Table 1.

As shown in FIG. 1C, the CQI Table 3 may shift the focused range of performance compared to the CQI Table 1 and the CQI Table 2. The shift in performance may be to a low end of the spectral efficiency range. The CQI Table 3 may enable a receiver (e.g., the UE 105) to report link rate capabilities down to 0.0586 bits/s/Hz, while limiting a maximum performance range to 4.5234 bits/s/Hz. The new lower limit of 0.0586 bits/s/Hz may represent an extension in performance associated with the use of up to 2.6 times more coding applied to the link than was previously available, which helps the link to be more reliable in poor locations. As further shown in FIG. 1C, the MCS Table 3 may include similar fields as the MCS Table 1 and MCS Table 2, but those fields may correspond to values provided in the CQI Table 3 rather than values provided in the CQI Table 1 and CQI Table 2. The MCS Table 3 may provide six new MCS levels with additional coding to improve reliability.

As shown in FIG. 1D, and by reference number 120, the base station 110-A may utilize a table that includes a list of target iBLER values not associated with a default iBLER value set for a CQI table. For example, as described above, the current LTE standard enables the base station 110-A to configure a specific MCS Table to be used for each UE 105 in a coverage area, and to configure a specific CQI Table to be used for each UE 105 in the coverage area. The configuration of both parameters may be independent of each other, which means that the base station 110-A may configure the MCS Table 3 to be used by the UE 105 along with the CQI Table 1 or any other combination of MCS table and CQI table that is supported by both the base station 110-A and the UE 105. Currently, a target iBLER value to be used by the UE 105 when computing CQI feedback is that which is mandated by the standard specification for each CQI table, as described above.

In some implementations, the base station 110-A may configure and utilize a table that includes a list of target iBLER values not associated with a default iBLER value set for a CQI table. For example, the base station 110-A may configure the target iBLER value regardless of the CQI table that is configured. Each CQI table may include a default iBLER value that may be assumed if the configuration process does not specify a replacement iBLER value. The default iBLER value of the CQI Table 1 is 10⁻¹, the default iBLER value of the CQI Table 2 is 10⁻¹, and the default iBLER value of the CQI Table 3 is 10⁻⁵ as currently mandated by the LTE specification. Default iBLER values of any additional CQI tables that are defined in the future may be set to whatever iBLER values are deemed appropriate for the additional CQI tables.

As further shown in FIG. 1D, the table may include a default iBLER value field (e.g., CQI-iBLER) specified for a CQI table and a target iBLER values field (e.g., the target transport block error rate (BER) column). The default iBLER value field may include iBLER values, such as 0, 1, 2, 3, 4, 5, 6, 7, and/or the like. The target iBLER values field may include iBLER values such as 0.1 (e.g., 10⁻¹), 0.01 (e.g., 10⁻²), 0.001 (e.g., 10⁻³), 0.0001 (e.g., 10⁻⁴), 0.00001 (e.g., 10⁻⁵), 0.000001 (e.g., 10⁻⁶), and/or the like. The target iBLER values may be utilized by the base station 110-A as candidates for selection. The selected target iBLER value may depend upon whether or not the UE 105 supports the selected target iBLER value for the CQI table being configured.

As shown in FIG. 1E, and by reference number 125, the base station 110-A may add a field for a CSI report configuration information element that enables the default iBLER value set for the CQI table to be overridden by the table. For example, the base station 110-A may add, to the CSI report configuration information element, a field that enables the base station 110-A to configure the iBLER value that the UE 105 should use for the CQI table that is being configured. In some implementations, the field for the CSI report configuration information element may enable the base station 110-A to utilize the table to override the default iBLER value set for the CQI table. In some implementations, additional changes may be made to relevant specifications as necessary in order to provide an indication as to which CQI tables are supported and to specify which iBLER values are supported for each CQI table.

As shown in FIG. 1F, and by reference number 130, the base station 110-A may provide, to the UE 105, a service that requires an iBLER value selected from the list of target iBLER values and that overrides the default iBLER value set for the CQI table. For example, the base station 110-A may select an iBLER value from the list of target iBLER values (e.g., provided in the table), and may provide, to the UE 105, the service that utilizes the selected iBLER value and that overrides the default iBLER value set for the CQI table. In some implementations, the default iBLER value may be a 10⁻¹ iBLER value and the iBLER value selected from the list of target iBLER values may be a 10⁻⁵ iBLER value, a 10⁻⁴ iBLER value, a 10⁻⁶ iBLER value, and/or the like. In some implementations, the service may include a service that provides increased building penetration by the base station 110-A, a service that provides additional link margin to overcome shadow fades, a service that provides an increased cell range for the base station 110-A, and/or the like.

As shown in FIG. 1G, and by reference number 135, the base station 110-A may define additional CQI tables for additional target iBLER values and may specify the additional CQI tables with a CSI report configuration information element. For example, the base station 110-A may define additional CQI tables for each additional target iBLER value that is desired and may specify the additional CQI tables using a CSI report configuration information element (e.g., provided to the UE 105). The base station 110-A may modify, in the CSI report configuration information element, an entry that enables a CQI Table to be specified in order to allow more tables (e.g., where table5-rM, table6-rN, and table7-rO, as shown in FIG. 1G, may correspond to new CQI Tables with pre-specified iBLER values.

As shown in FIG. 1H, and by reference number 140, the base station 110-A may provide, to the UE 105, a service that requires one of the additional target iBLER values associated with one of the additional CQI tables. For example, the base station 110-A may provide a service to the UE 105. The service may require one of the additional target iBLER values (e.g., a 10⁻⁵ iBLER value) associated with one of the additional CQI tables. In some implementations, the service may include a service that provides increased building penetration by the base station 110-A, a service that provides additional link margin to overcome shadow fades, a service that provides an increased cell range for the base station 110-A, and/or the like.

As shown in FIG. 1I, and by reference number 145, the base station 110-A may maintain a set of candidate configurations to be applied to the UE 105 based on channel conditions for the UE 105. For example, the base station 110-A may maintain a data structure (e.g., a table) that includes the set of candidate configurations to be applied to the UE 105 based on the channel conditions for the UE 105. The candidate configurations may include a poor conditions configuration (e.g., for poor channel conditions for the UE 105), a medium conditions configuration (e.g., for medium channel conditions for the UE 105), and a great conditions configuration (e.g., for great channel conditions for the UE 105). The candidate configurations may be associated with an MCS table to configure, a CQI table to configure, and a power control offset adjustment. For example, the poor conditions configuration may configure the MCS Table 3, may configure the CQI Table 1, and may apply a six dB power control offset adjustment. The medium conditions configuration may configure the MCS Table 1, may configure the CQI Table 1, and may apply a zero dB power control offset adjustment. The great conditions configuration may configure the MCS Table 2, may configure the CQI Table 2, and may apply a zero dB power control offset adjustment.

In some implementations, the base station 110-A may utilize the set of candidate configurations to mimic an ability to use the CQI Table 3 with a 10⁻¹ iBLER target. To improve in-building penetration and coverage, as well as to improve coverage at a cell edge, the base station 110-A may configure the use of the MCS Table 3 and the CQI Table 3, but may cause the UE 105 to compute CQI based on the CQI Table 3 using a 10⁻¹ iBLER target. As described above, the CQI process may utilize reference signals, transmitted by the base station 110-A, that enable the UEs 105 in a coverage area to perform measurements of a received signal strength of the reference signals. Once the UE 105 has measured the signal strength, the UE 105 may compute a pathloss associated with a link based on how much power was transmitted in the reference signals. Combined with other measurements as to a quantity of interference being experienced, the UE 105 may determine a corresponding signal-to-interference ratio and a CQI value to provide as feedback.

As shown above in FIGS. 1B and 1C, a vast majority of the rows in the CQI Table 1 and the CQI Table 3 are identical and are shifted by two CQI rows. Thus, the CQI Table 3 is a simple shifted version of the CQI Table 1 with the two highest spectral efficiency rows dropped from the CQI Table 1 and two new low spectral efficiency rows added below a previous lowest spectral efficiency row in the CQI Table 1. The UE 105 may compute a CQI report based on reference signals that are transmitted by the base station 110-A. In order to improve an ability of the UE 105 to accurately measure these reference signals, reference signals of adjacent cells may be transmitted on orthogonal resources so that nearby cells in the area could mute their transmissions on those resources and allow the UE 105 to perform a more accurate measurement without extra interference that would otherwise be provided by the adjacent cells. But muting those resources meant that there was unused power headroom available that could be used to further improve the measurement by adding it to a power level of the transmitted reference signals. The UE 105 may be made aware of this when performing the CQI measurement, or else the UE 105 may assume that the boosted reference signals are indicative of a power level that would be received for an actual data transmission.

To enable the base station 110-A to inform the UE 105 about a quantity by which the reference signals are boosted (e.g., so that the UE 105 may make a correct determination of a proper CQI value to provide as feedback to the base station 110-A), a power control offset field may be defined within a CSI resource information element. The power control offset field may convey, to the UE 105, a relative power level of data transmission resource elements that can be expected relative to a measured power of reference signal resource elements. The allowable values that may be indicated in the power control offset field may include any integer value between −8 dB and +15 dB. For example, if two nearest neighboring cells have reference signals placed on orthogonal resources, a serving cell may mute those resources in order to improve the measurements at those cells, and vice versa. A power from the two sets of resource elements may be added to a power of the serving cell's reference signal transmissions, thus increasing a transmit power level by a factor of three, which is 4.77 dB. In order to prevent a CQI computation of the UE 105 from being off by a significant amount, the base station 110-A may set a power offset value to −5 dB in order to inform the UE 105 that the reference signals are boosted and that the UE 105 should compute CQI assuming that the data transmissions will be 5 dB weaker than the measured reference signals.

The base station 110-A may utilize the power offset value to cause the UE 105 to utilize a shifted version of the CQI Table 1 for CQI calculations. Whenever the base station 110-A configures the UE 105 to use the MCS Table 1 and the CQI Table 1, the base station 110-A may send to the UE 105 a correct power offset value that represents a correct amount of boost that is applied to the reference signals. However, when the base station 110-A wants to configure the UE 105 to use the MCS Table 3 and a shifted version of the CQI Table 1, the base station 110-A may add a desired amount of shift to the power offset value when informing the UE 105 of the amount by which the reference signals are boosted. In the normal case, the base station 110-A may want the UE 105 to shift the CQI Table 1 by about 4 dB, so instead of transmitting a power offset value of −5 dB for the case where the resources for two cells are muted, the base station 110-A may transmit a power offset value of −1 dB (e.g., −5+4=−1 dB) to inform the UE 105 of the boost value. This may result in the UE 105 unknowingly applying a 4 dB shift to the CQI Table 1. Once a CQI value is fed back to the base station 110-A by the UE 105, the base station 110-A may remove the 4 dB shift from the CQI value in order to compute a true value of the CQI feedback.

As shown in FIG. 1J, and by reference number 150, the base station 110-A may process the channel conditions for the UE 105, with a model, to determine a candidate configuration, from the set of candidate configurations, to be applied to the UE 105. For example, the base station 110-A may include a model that is described below in connection with FIG. 1K. In some implementations, the base station 110-A may utilize the model to determine a candidate configuration to be applied to the UE 105 from the set of candidate configurations and based on the channel conditions for the UE 105. For example, the base station 110-A may determine a poor conditions configuration for poor channel conditions, a medium conditions configuration for medium channel conditions, or a great conditions configuration for great channel conditions.

FIG. 1K depicts an example of the model that may be utilized by the base station 110-A to determine a candidate configuration to be applied to the UE 105 from the set of candidate configurations and based on the channel conditions for the UE 105. In one example, the base station 110-A may select CQI feedback value thresholds as Tp2m=CQI 8, Tm2g=CQI 8, Tm2p=CQI 4, and Tg2m=CQI 4. As shown in FIG. 1K, the model may determine whether a current UE configuration is a poor conditions configuration. If the model determines that the current UE configuration is not a poor conditions configuration, the model may determine whether the current UE configuration is a great conditions configuration. If the model determines that current UE configuration is not a great conditions configuration, the model may determine whether the current UE configuration is a medium conditions configuration. If the model determines that current UE configuration is not a medium conditions configuration, the model may configure the UE 105 with a default configuration.

If the model determines that the current UE configuration is a poor conditions configuration and that the UE filtered CQI transition is above Tp2m, the model may reconfigure the UE 105 with the medium conditions configuration. If the model determines that the current UE configuration is a great conditions configuration and that the UE filtered CQI transition is below Tg2m, the model may reconfigure the UE 105 with the medium conditions configuration. If the model determines that the current UE configuration is a medium conditions configuration and that the UE filtered CQI transition is above Tm2g, the model may reconfigure the UE 105 with the great conditions configuration. If the model determines that the current UE configuration is a medium conditions configuration, and that the UE filtered CQI transition is not above Tm2g but is below Tm2p, the model may reconfigure the UE 105 with the poor conditions configuration.

As shown in FIG. 1L, and by reference number 155, the base station 110-A may utilize radio resource control (RRC) signaling to configure the UE 105 with the candidate configuration. For example, the base station 110-A may generate a message (e.g., an RRC message) that includes the candidate configuration. The base station 110-A may provide the RRC message to the UE 105, and the UE 105 may be configured with the candidate configuration based on the message. In some implementations, the RRC message may include a physical data shared channel (PDSCH) configuration information element with an MCS Table field set to a desired MCS table; a CSI resource information element with a power control offset field set to an adjusted power control offset value based on a CSI resource configuration identifier set to a unique index that identifies a set of non-zero-power CSI resources that will be used for the measurement and based on a power control offset ratio and a power control offset adjustment (e.g., a quantity of decibels of shift that is desired in the CQI table that is being configured); a CSI report configuration information element with a resources for channel measurement field set to a unique CSI resource configuration identifier index that identifies a desired set of non-zero-power CSI resources to be used for the measurement and a correct power control offset that provides a desired shift of the specified CQI Table, and a CQI Table field set to the desired CQI table; and/or the like.

As further shown in FIG. 1L, and by reference number 160, the base station 110-A may provide, to the UE 105, a service that requires an iBLER value that overrides a default iBLER value set for a CQI table. For example, the base station 110-A may select an iBLER value that overrides a default iBLER value set for a CQI table, and may provide, to the UE 105, the service that utilizes the selected iBLER value and that overrides the default iBLER value set for the CQI table. In some implementations, the default iBLER value may be a 10⁻¹ iBLER value and the iBLER value may be a 10⁻⁵ iBLER value. In some implementations, the service may include a service that provides increased building penetration by the base station 110-A, a service that provides additional link margin to overcome shadow fades, a service that provides an increased cell range for the base station 110-A, and/or the like.

In one example, the UE 105 may be located in a decent location with an actual signal-to-interference-plus-noise ratio (SINR) value of 3 dB. Because the UE 105 is located in a decent location, the UE 105 may be configured to use the MCS Table 1 and the CQI Table 1. Because the actual SINR is 3 dB and reference signals are boosted by 4 dB, the UE 105 may calculate a computed SINR of 7 dB. If the UE 105 is notified that the power control offset is-4 dB, the UE 105 may adjust the computed SINR down by 4 dB to obtain a final SINR value of 3 dB. The UE 105 may examine the CQI Table 1 and may determine that an SINR value of 3 dB maps to a CQI index of six (6). The UE 105 may provide as feedback a CQI index of 6 to the base station 110-A. The base station 110-A may examine the CQI Table 1 and may process the SINR of 3 dB with the model.

In another example, the UE 105 may be located in a poor location with an actual SINR value of −9 dB. The reference signals may be boosted by 4 dB, so the UE 105 may calculate an SINR value of −5 dB. The UE 105 may be misinformed that the boost value is 0 dB, and may compute a final SINR value of −5 dB. The UE 105 may examine the CQI Table 1 to determine that a CQI index of 2 maps to an SINR value of −5 dB. The UE 105 may provide feedback of the CQI index of 2 to the base station 110-A. Upon receiving the CQI index of 2, base station 110-A may example the CQI Table 1 and may determine that a CQI index of 2 maps to an SINR value of −5 dB. Knowing that it has misinformed the UE 105 that the boost value is 0 dB, the base station 110-A may adjust the mapped SINR value down by 4 dB to account for the misinformation, resulting in a final SINR value of −9 dB. The base station 110-A may perform additional processing based on the final SINR value of −9 dB.

In this way, the base station 110 provides services based on an iBLER determined from a translated CQI table. For example, the base station 110 may configure a target iBLER value regardless of a CQI table that is configured. Each CQI table may include a default iBLER value that may be utilized when a configuration process fails to specify a replacement iBLER value. The base station 110 may specify a default iBLER value of the CQI Table 1 as 10⁻¹, a default iBLER value of the CQI Table 2 as 10⁻¹, and a default iBLER values of the CQI Table 3 as 10⁻⁵. The base station 110 may set default iBLER values of any additional CQI tables that are defined in the future to values that are deemed appropriate for the additional CQI tables. Thus, the base station 110 may conserve computing resources, networking resources, and/or other resources that would have otherwise been consumed by failing to utilize new MCS table options that provide more channel coding, failing to enable use of the MCS Table 3 and use of CQI Table 3, failing to provide services associated with a particular iBLER (e.g., increased building penetration by a base station 110, additional link margin to overcome shadow fades, increased cell range for a base station 110, etc.), and/or the like.

As indicated above, FIGS. 1A-1L are provided as an example. Other examples may differ from what is described with regard to FIGS. 1A-1L. The number and arrangement of devices shown in FIGS. 1A-1L are provided as an example. In practice, there may be additional devices, fewer devices, different devices, or differently arranged devices than those shown in FIGS. 1A-1L. Furthermore, two or more devices shown in FIGS. 1A-1L may be implemented within a single device, or a single device shown in FIGS. 1A-1L may be implemented as multiple, distributed devices. Additionally, or alternatively, a set of devices (e.g., one or more devices) shown in FIGS. 1A-1L may perform one or more functions described as being performed by another set of devices shown in FIGS. 1A-1L.

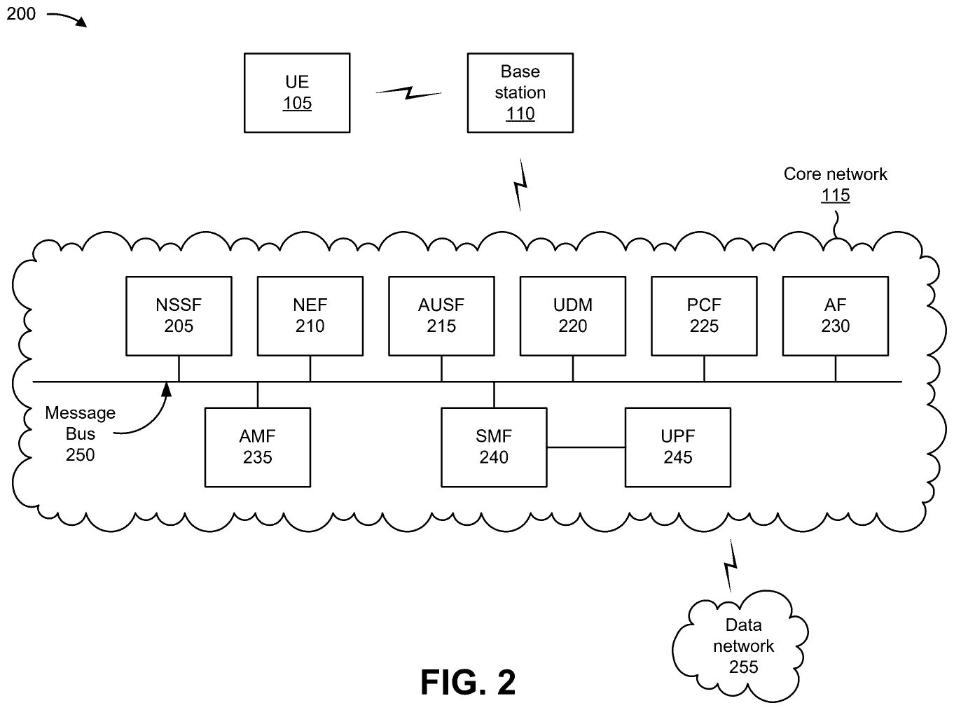

FIG. 2 is a diagram of an example environment 200 in which systems and/or methods described herein may be implemented. As shown in FIG. 2, example environment 200 may include the UE 105, the base station 110, the core network 115, and a data network 255. Devices and/or networks of example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane quality of service (QOS), among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

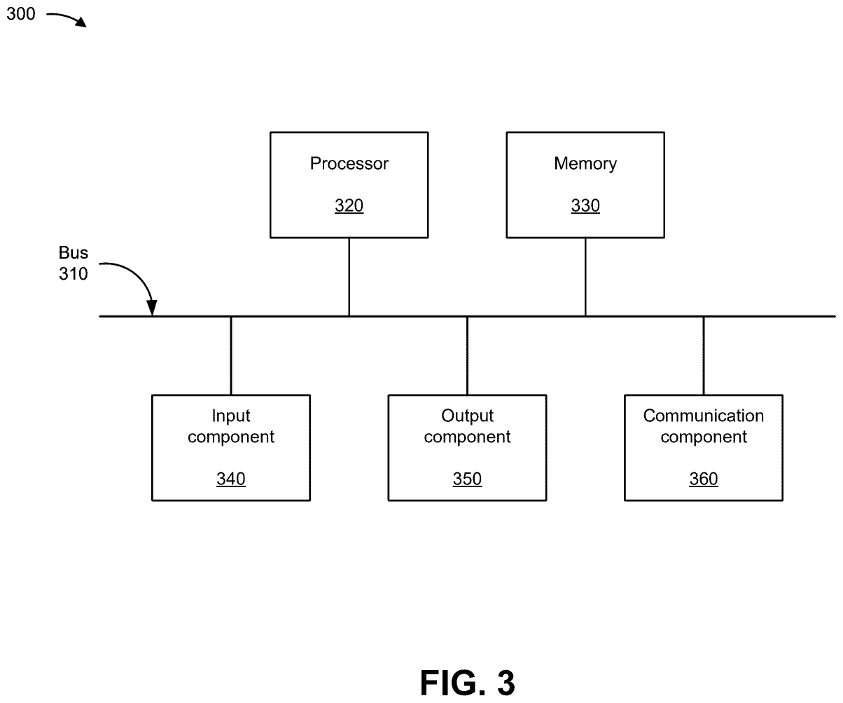

FIG. 3 is a diagram of example components of a device 300, which may correspond to the UE 105, the base station 110, the NSSF 205, the NEF 210, the AUSF 215, the UDM component 220, the PCF 225, the AF 230, the AMF 235, the SMF 240, and/or the UPF 245. In some implementations, the UE 105, the base station 110, the NSSF 205, the NEF 210, the AUSF 215, the UDM component 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

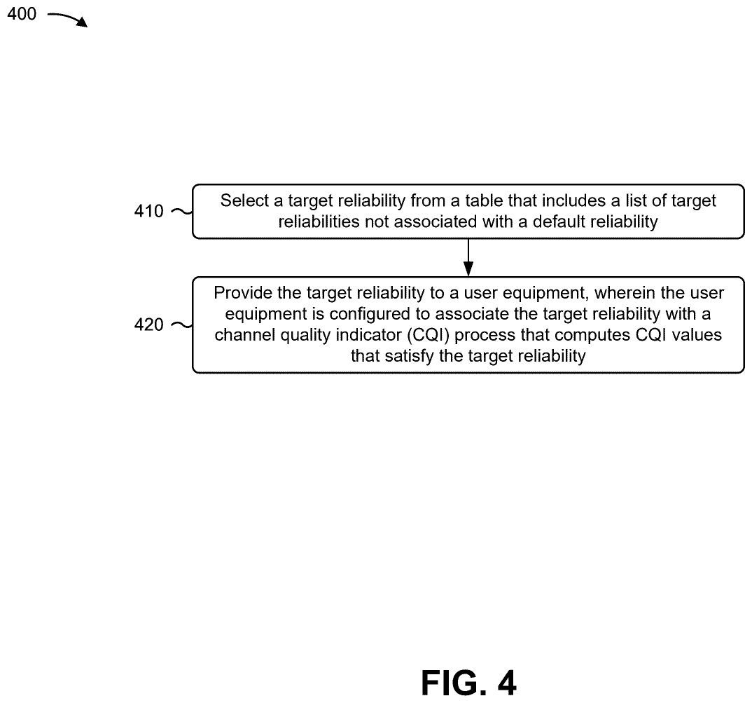

FIG. 4 is a flowchart of an example process 400 for providing services based on an iBLER determined from a translated CQI table. In some implementations, one or more process blocks of FIG. 4 may be performed by a network device (e.g., the base station 110). In some implementations, one or more process blocks of FIG. 4 may be performed by another device or a group of devices separate from or including the device, such as a UE (e.g., the UE 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include selecting a target reliability from a table that includes a list of target reliabilities not associated with a default reliability (block 410). For example, the network device may select a target reliability from a table that includes a list of target reliabilities not associated with a default reliability, as described above. In some implementations, the target reliability includes a target iBLER value. In some implementations, the table includes a list of target iBLER values. In some implementations, the target reliability overrides the default reliability.

As further shown in FIG. 4, process 400 may include providing the target reliability to a UE, wherein the UE is configured to associate the target reliability with a CQI process that computes CQI values that satisfy the target reliability (block 420). For example, the network device may provide the target reliability to a UE, as described above. In some implementations, the UE is configured to associate the target reliability with a CQI process that computes CQI values that satisfy the target reliability. In some implementations, providing the target reliability to the UE includes determining an index associated with the target reliability, and providing the index associated with the target reliability to the UE. In some implementations, the index includes a field added to a CSI report configuration information element. In some implementations, the UE is configured to associate the target reliability with a CQI table. In some implementations, the target reliability overrides a default reliability associated with the CQI table.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

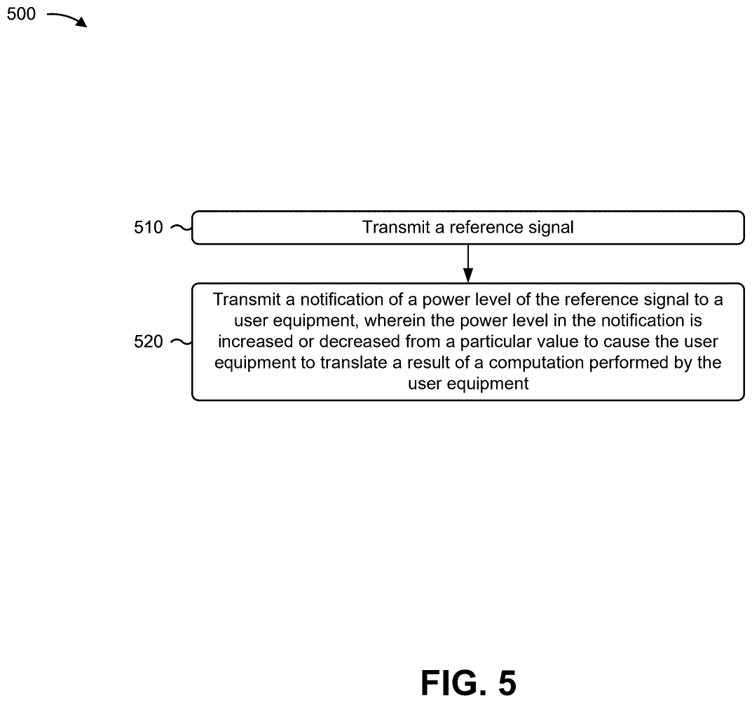

FIG. 5 is a flowchart of an example process 500 for providing services based on an iBLER determined from a translated CQI table. In some implementations, one or more process blocks of FIG. 5 may be performed by a network device (e.g., the base station 110). In some implementations, one or more process blocks of FIG. 5 may be performed by another device or a group of devices separate from or including the device, such as a UE (e.g., the UE 105). Additionally, or alternatively, one or more process blocks of FIG. 5 may be performed by one or more components of the device 300, such as the processor 320, the memory 330, the input component 340, the output component 350, and/or the communication component 360.

As shown in FIG. 5, process 500 may include transmitting a reference signal (block 510). For example, the network device may transmit a reference signal, as described above.

As further shown in FIG. 5, process 500 may include transmitting a notification of a power level of the reference signal to a UE, wherein the power level in the notification is increased or decreased from a particular value to cause the UE to translate a result of a computation performed by the UE (block 520). For example, the network device may transmit a notification of a power level of the reference signal to a UE, as described above. In some implementations, the power level in the notification is increased or decreased from a particular value to cause the UE to translate a result of a computation performed by the UE. In some implementations, the computation is a calculation of a CQI value. In some implementations, the result causes the UE to select a CQI index from a CQI table. In some implementations, translation of the result shifts an applicable range of a CQI table. In some implementations, the shift in the applicable range of the CQI table results in the CQI table supporting one or more of increased building penetration, increased shadow fading, increased cell range, or decreased downlink signal to interference and noise ratio.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
selecting, by a network device, a target reliability from a table that includes a list of target reliabilities not associated with a default reliability; and
providing, by the network device, the target reliability to a user equipment,
wherein the user equipment is configured to associate the target reliability with a channel quality indicator (CQI) process that computes CQI values that satisfy the target reliability.

2. The method of claim 1, wherein the target reliability includes a target initial block error rate (iBLER) value.

3. The method of claim 1, wherein the table includes a list of target initial block error rate (iBLER) values.

4. The method of claim 1, wherein providing the target reliability to the user equipment comprises:
determining an index associated with the target reliability; and
providing the index associated with the target reliability to the user equipment.

5. The method of claim 4, wherein the index includes a field added to a channel state information report configuration information element.

6. The method of claim 1, wherein the target reliability overrides the default reliability.

7. The method of claim 1, wherein the user equipment is configured to associate the target reliability with a CQI table.

8. The method of claim 7, wherein the target reliability overrides a default reliability associated with the CQI table.

9. A method, comprising:
transmitting, by a network device, a reference signal; and
transmitting, by the network device, a notification of a power level of the reference signal to a user equipment,
wherein the power level in the notification is increased or decreased from a particular value to cause the user equipment to translate a result of a computation performed by the user equipment.

10. The method of claim 9, wherein the computation is a calculation of a channel quality indicator (CQI) value.

11. The method of claim 9, wherein the result causes the user equipment to select a channel quality indicator (CQI) index from a CQI table.

12. The method of claim 9, wherein translation of the result shifts an applicable range of a channel quality indicator (CQI) table.

13. The method of claim 12, wherein the shift in the applicable range of the CQI table results in the CQI table supporting one or more of increased building penetration, increased shadow fading, increased cell range, or decreased downlink signal to interference and noise ratio.

14. A non-transitory computer-readable medium storing a set of instructions, the set of instructions comprising:
one or more instructions that, when executed by one or more processors of a network device, cause the network device to:
transmit a reference signal; and
transmit a notification of a power level of the reference signal to a user equipment,
wherein the power level in the notification is increased or decreased from a particular value to cause the user equipment to translate a result of a computation performed by the user equipment.

15. The non-transitory computer-readable medium of claim 14, wherein the computation is a calculation of a channel quality indicator (CQI) value.

16. The non-transitory computer-readable medium of claim 14, wherein the result causes the user equipment to select a channel quality indicator (CQI) index from a CQI table.

17. The non-transitory computer-readable medium of claim 14, wherein translation of the result shifts an applicable range of a channel quality indicator (CQI) table.

18. The non-transitory computer-readable medium of claim 17, wherein the shift in the applicable range of the CQI table results in the CQI table supporting one or more of increased building penetration, increased shadow fading, increased cell range, or decreased downlink signal to interference and noise ratio.

19. The non-transitory computer-readable medium of claim 14, wherein the one or more instructions, that cause the network device to transmit the notification of the power level of the reference signal to the user equipment, cause the network device to:
utilize radio resource control signaling to transmit the notification of the power level of the reference signal to the user equipment.

20. The non-transitory computer-readable medium of claim 14, wherein the power level in the notification is a power control offset adjustment.
